(19) United States
(12) Patent Application Publication
(10) Pub. No.: US 2013/0321290 A1
(43) Pub. Date: Dec. 5, 2013

(54) METHOD AND APPARATUS FOR SENSING TOUCH INPUT

(71) Applicants: Yoon Seok OH, Suwon (KR); Tah Joon Park, Suwon (KR); Sang Hyun Sim, Suwon (KR); Bo Yle Seo, Suwon (KR); Ji Hoon Kim, Suwon (KR)

(72) Inventors: Yoon Seok OH, Suwon (KR); Tah Joon Park, Suwon (KR); Sang Hyun Sim, Suwon (KR); Bo Yle Seo, Suwon (KR); Ji Hoon Kim, Suwon (KR)

(73) Assignee: SAMSUNG ELECTRO-MECHANICS CO., LTD., SUWON (KR)

(21) Appl. No.: 13/588,184

(22) Filed: Aug. 17, 2012

(30) Foreign Application Priority Data
May 30, 2012 (KR) 10-2012-0057385

(51) Int. Cl. G06F 3/041

(52) U.S. Cl. 345/173

(57) ABSTRACT

There are provided a method and an apparatus for sensing a touch input. The method of sensing a touch input includes selecting at least a portion of a plurality of nodes in which a sensing signal is generated by a touch input, defining a node group according to the plurality of selected nodes, generating two or more first sub-node groups by dividing a plurality of nodes included in the node group, based on a first axial direction, and determining a first touch vector of the node group by calculating centric coordinates of the respective two or more first sub-node groups.

### CROSS-REFERENCE TO RELATED APPLICATIONS

This application claims the priority of Korean Patent Application No. 10-2012-0057385 filed on May 30, 2012, in the Korean Intellectual Property Office, the disclosure of which is incorporated herein by reference.

### BACKGROUND OF THE INVENTION

1. Field of the Invention

The present invention relates to a method and an apparatus for sensing a touch input, and more particularly, to a method and an apparatus for sensing a touch input able to determine touch input directivity as well as coordinates thereof to provide various user input methods.

2. Description of the Related Art

Touch sensing devices such as a touchscreen and a touch pad are input devices, capable of providing a user with an intuitive input method, which may be integrally provided with a display device and are widely used in various portable electronic devices such as a cellular phone, a personal digital assistant (PDA), a navigation device, or the like. As demand for smart phones has recently increased, an adoption rate of a touchscreen as a touch sensing device, able to provide various input methods in a limited form factor, increases on a day to day basis.

A touchscreen applied to a portable device may be largely divided into a resistive-type touchscreen and a capacitive-type touchscreen according to a method of sensing a touch input. The capacitive-type touchscreen has a relatively long life and is capable of embodying various input methods and gestures easily, so that its adoption rate gets higher and higher. In particular, the capacitive-type touchscreen is capable of embodying a multi-touch interface easier than the resistive-type touchscreen, thereby being widely applied to a device such as a smart phone.

A capacitive touchscreen includes a plurality of electrodes having a fixed pattern, and a plurality of nodes in which a change in capacitance is generated by a touch input are defined by the plurality of electrodes. A plurality of nodes distributed on a two-dimensional plane may generate changes in self-capacitance or mutual-capacitance by a touch input, and calculate coordinates of a touch input by applying a weighted average calculation method to a change in capacitance generated in the plurality of nodes. Especially, as various applications for smart phones and tablet PCs have recently been developed, along with growth in distribution of smart phones and tablet PCs, an additional function, able to calculate or determine a direction as well as simple coordinates of a touch input, tends to be required in a touchscreen device.

In the following related art documents, Patent Document 1, related to a method of determining coordinates of a capacitive-type touchscreen device, merely discloses contents for determining coordinates and a palm touch by grouping a node where a sensing signal having a strength greater than a predetermined strength is generated among a plurality of nodes, but does not disclose any contents for calculating a direction of a touch input. In addition, Patent Document 2 implies contents for calculating a direction of a touch input; however, it has nothing to do with the present invention.

### Related Art Documents

(Patent Document 1) Korean Patent Laid-Open Publication No. 10-2001-0040410
(Patent Document 2) U.S. Patent Application Publication No. 2010/0289754

### SUMMARY OF THE INVENTION

An aspect of the present invention provides a method and an apparatus for sensing a touch input which determine a node group including nodes in which a change in capacitance generated by an actual touch input occurs, among a plurality of nodes in which a change in capacitance occurs due to a touch input, divides the node group into two or more sub-node groups according to a specific direction, calculates centric coordinates of the respective divided sub-node groups, and determines a directional vector of the touch input therefrom, thereby sensing direction as well as coordinates of the touch input through a simple method.

According to an aspect of the present invention, there is provided a method of sensing a touch input, including: selecting at least a portion of a plurality of nodes in which a sensing signal is generated by a touch input; defining a node group according to the plurality of selected nodes; generating two or more first sub-node groups by dividing the plurality of nodes included in the node group based on a first axial direction; and determining a first touch vector of the node group by calculating centric coordinates of the respective two or more first sub-node groups.

In the determining, the centric coordinates may be calculated according to whether the sensing signal is generated in a node included in each of the two or more first sub-node groups.

In the generating, the two or more first sub-node groups may be generated by dividing the node group based on the first axial direction intersecting a major axis direction of the node group.

The method may further include generating two or more second sub-node groups by dividing the node group based on a second axial direction intersecting the first axial direction, and determining a second touch vector of the node group by calculating centric coordinates of the respective two or more second sub-node groups.

The method may further include determining a direction of the node group based on the first touch vector and the second touch vector.

In the determining, a direction of the node group may be determined to be absent when a direction of the first touch vector is perpendicular to the first axial direction and a direction of the second touch vector is perpendicular to the second axial direction.

A direction of the node group may be determiend to be absent when the sensing signal is determined to be generated in all nodes included in the node group.

The method may further include determining coordinates of the node group by calculating an average of centric coordinates of the respective two or more first sub-node groups.

According to another aspect of the present invention, there is provided an apparatus for sensing a touch input, including: a panel unit including a plurality of nodes in which a sensing signal is generated by a touch input; and an operation unit determining touch input information, based on the sensing signal, wherein the operation unit defines a node group including at least a portion of the plurality of nodes based on the sensing signal, generates two or more first sub-node groups by dividing the node group based on a first axial direction, and calculates a first vector of the touch input by calculating centric coordinates of the respective two or more first sub-node groups.

The operation unit may include a sensing circuit unit detecting a change in capacitance generated in the plurality of nodes by the touch input, and a signal conversion unit generating the sensing signal from the change in capacitance.

The operation unit may calculate the centric coordinates based on whether the sensing signal is generated in a node included in each of the two or more first sub-node groups.

The operation unit may generate the two or more first sub-node groups by dividing the node group based on the first axial direction intersecting a major direction of the node group.

The operation unit may generate two or more second sub-node groups by dividing the node group based on a second axial direction intersecting the first axial direction, and determine a second touch vector of the node group by calculating the centric coordinates of the respective two or more second sub-node groups.

A direction of the node group may be determined based on the first touch vector and the second touch vector.

The operation unit may determine that a direction of the node group is absent when a direction of the first touch vector is perpendicular to the first axial direction and a direction of the second touch vector is perpendicular to the second axial direction.

The operation unit may determine that a direction of the node group is absent when the sensing signal is generated in all nodes included in the node group.

The operation unit may determine coordinates of the node group by calculating an average of the centric coordinates of the respective two or more first sub-node groups.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view depicting an exterior of an electronic device equipped with a touch sensing device according to an embodiment of the present invention;

FIGS. 2 and 3 are plan and side views illustrating the touch sensing device according to an embodiment of the present invention;

FIG. 4 is a diagram depicting the touch sensing device according to an embodiment of the present invention;

FIG. 5 is a flowchart provided in explaining a method of sensing a touch input according to an embodiment of the present invention; and

FIGS. 6 through 9 are diagrams provided in explaining the method of sensing a touch input according to an embodiment of the present invention.

### DETAILED DESCRIPTION OF THE EMBODIMENTS

Embodiments of the present invention will now be described in detail with reference to the accompanying drawings. In the following detailed description, only certain embodiments of the present invention have been shown and described, simply by way of illustration. As those skilled in the art would realize, the described embodiments may be modified in various different manners, all without departing from the spirit or scope of the present invention. This invention may, however, be embodied in many different forms and should not be construed as being limited to the embodiments set forth herein. Rather, these embodiments are provided so that this disclosure will be thorough and complete, and will fully convey the scope of the invention to those skilled in the art. Like reference numerals denote same or like elements throughout.

Hereinafter, the present invention will be described in detail by explaining embodiments of the invention with reference to the attached drawings so that the present invention would have been obvious to one of ordinary skill in the art.

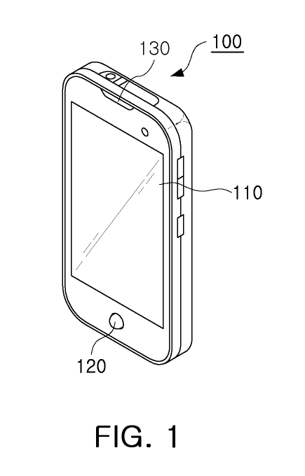

FIG. 1 is a perspective view depicting an electronic device in which a contact sensing device may be applied according to an embodiment of the present invention. Referring to FIG. 1, an electronic device 100 according to an embodiment of the present invention may include a display device 110 for outputting an image, an input unit 120 and an audio unit 130 for inputting and outputting voice information, and it may be equipped with a contact sensing device integrated with the display device 110.

As illustrated in FIG. 1, mobile devices are generally equipped with a touch sensing device integrated with a display device, and the touch sensing device should have a relatively high light penetration ratio so that an image displayed by the display device may penetrate therethrough. Accordingly, the touch sensing device may be embodied by forming a sensing electrode of a material which is transparent and has electrical conductivity such as Indium-Tin Oxide (ITO), Indium Zinc Oxide (IZO), Zinc Oxide (ZnO), Carbon Nano Tubes (CNTs) or Graphene on a base substrate of a transparent film material such as Polyethylene terephthalate (PET), polycarbonate (PC), polyethersulfone (PES), polymide (PI), or the like. In a bezel area of a display device, a wiring pattern connected to the sensing electrode, formed of a transparent conductive material, is arranged, and the wiring pattern is visually covered by the bezel area and may be formed of a metal such as silver Ag, copper Cu, or the like.

In the case that it is unnecessary to integrate the touch sensing device of the present invention with a display device like a touch pad of a laptop computer, the touch sensing device may be manufactured simply by patterning the sensing electrode with metals on a circuit substrate. However, for convenience of explanation, the following explains a method and an apparatus for sensing a touch input according to an embodiment of the present invention by referring to a case of a touchscreen.

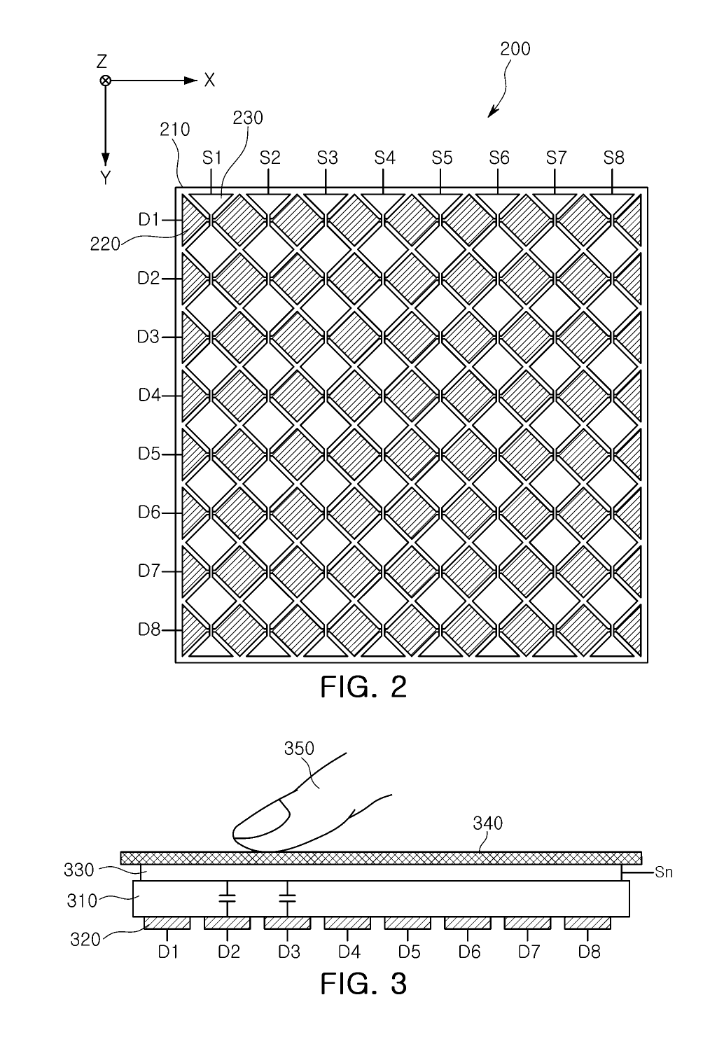

FIG. 2 is a plan view illustrating a touch sensing panel connected electrically to the touch sensing device according to an embodiment of the present invention.

Referring to FIG. 2, a touch sensing panel 200 according to an embodiment of the present invention may include a substrate 210 and a plurality of sensing electrodes 220 and 230 arranged thereon. Although not illustrated in FIG. 2, respective sensing electrodes among the plurality of sensing electrodes 220 and 230 may be electrically connected to a wiring pattern of a circuit substrate adhered to a terminal of the substrate 210 through a wiring and a bonding pad. A controller integration circuit is installed on the circuit substrate, whereby a sensing signal generated in the plurality of sensing electrodes 220 and 230 may be detected and a touch input therefrom may be determined.

A touchscreen device has the substrate 210, which may be a transparent substrate where the sensing electrodes 220 and 230 are formed and may be formed of plastic materials such as Polymide (PI), Polymethylmethacrylate (PMMA), Polyethyleneterephthalate (PET) or Polycarbonate (PC), or tempered glass. In addition, in an area, besides an area in which the sensing electrodes 220 and 230 are formed, where a wiring connected to the sensing electrodes 220 and 230 is arranged, a predetermined printing area for visually covering a wiring which is usually formed of a non-transparent metal may be formed on the substrate 210.

The plurality of sensing electrodes 220 and 230 may be disposed on a side or both sides of the substrate 210, and the touchscreen device may be formed of Indium Tin-Oxide (ITO), Indium Zinc Oxide (IZO), Zinc Oxide (ZnO), Carbon Nano Tubes (CNTs), or Graphene-materials, which are transparent and electrically conductive. Sensing electrodes 220 and 230 having a diamond pattern are illustrated in FIG. 2; however, various types of polygonal patterns such as rectangular and triangular type patterns may be provided.

The plurality of sensing electrodes 220 and 230 include a first electrode 220 extending in an X axis direction and a second electrode 230 extending in a Y axis direction. The first electrode 220 and the second electrode 230 may be disposed at both sides of the substrate 210, or may be disposed on different substrates 210 and intersected with each other. When the first electrode 220 and the second electrode 230 are disposed all on a side of the substrate 210, a predetermined insulation layer may be partially formed at an intersecting point of the first electrode 220 and the second electrode 230.

A device, which senses a touch input by being electrically connected to the plurality of sensing electrodes 220 and 230, detects a change in capacitance generated in the plurality of sensing electrodes 220 and 230 by a touch input and senses the touch input accordingly. The first electrode 220 may be connected to a channel which is defined as D1 to D8 in a controller integration circuit to receive an applied predetermined driving signal, and the second electrode 230 may be connected to a channel defined as S1 to S8 to be used in detecting, by a touch sensing device, a sensing signal. Here, the controller integrated circuit may detect a change in mutual-capacitance which is generated between the first electrode 220 and the second electrode 230 with a sensing signal, apply a driving signal sequentially to respective first electrodes 220, and detect a change in capacitance at the second electrode 230 at the same time.

FIG. 3 is a cross-sectional diagram depicting a section of the touch sensing panel illustrated in FIG. 2.

FIG. 3 is a cross-sectional diagram depicting a section of the touch sensing panel 200 of FIG. 2 cut by a Y-Z plane. A cover lens 340 having a touch applied thereto may further be included, in addition to the substrate 310 and the plurality of sensing electrodes 320 and 330 illustrated in FIG. 2. The cover lens 340 is installed on the second electrode 330 used in detecting a sensing signal to receive a touch input applied from a touch object 350 such as a finger.

When a driving signal is sequentially applied to the first electrodes 320 through the channels D1 to D8, mutual-capacitance is generated between the first electrode 320 to which the driving signal is applied, and the second electrode 330. When a driving signal is applied sequentially to the first electrodes 320, a change in capacitance may occur in the mutual-capacitance generated between the first electrode 320 and the second electrode 330 close by an area touched by the touch object 350. The change in capacitance may be proportional to an area of an overlapped region between the first electrode 320 and the second electrode 330 where the touch object 350 and a driving signal are applied, and the mutual-capacitance generated between the first electrodes 320 respectively connected to the channels D2 and D3, and the second electrode 330, may be affected by the touch object 350 in FIG. 3.

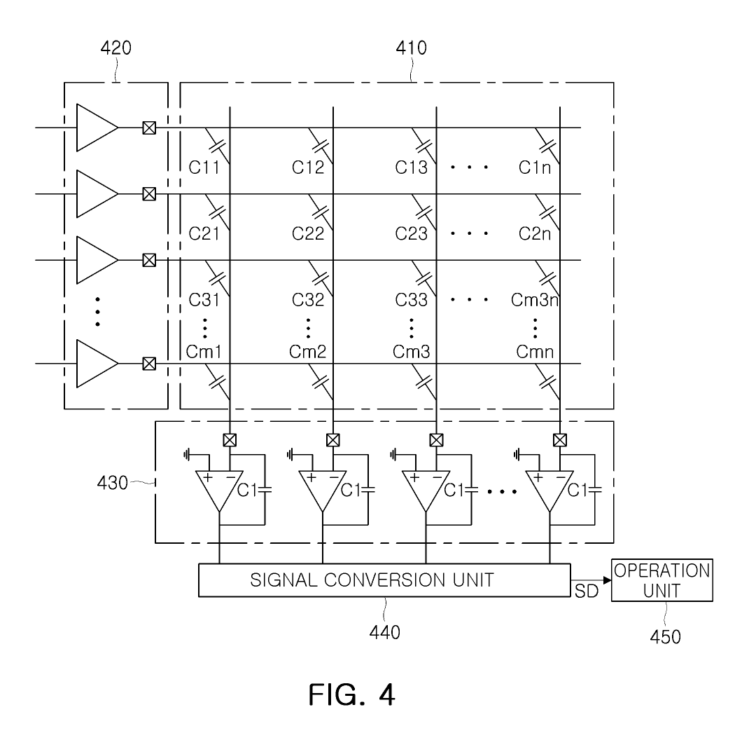

FIG. 4 is a block diagram depicting a touch sensing device according to an embodiment of the present invention.

Referring to FIG. 4, the touch sensing device according to an embodiment of the present invention may include a panel unit 410, a driving circuit unit 420, a sensing circuit unit 430, a signal conversion unit 440 and an operation unit 450. The panel unit 410 includes a plurality of first electrodes extending in a first axial direction, i.e., a horizontal direction of FIG. 4, and a plurality of second electrodes extending in a second axial direction, i.e., a vertical direction of FIG. 4, intersecting the first axis, and a change in capacitance C11 to Cmn occurs at a plurality of nodes in which the first electrode and the second electrode intersect each other. The change in capacitance C11 to Cmn occurred at the plurality of nodes may be a change in mutual-capacitance generated by a driving signal applied to the first electrode by the driving circuit unit 420. On the other hand, the driving circuit unit 420, the sensing circuit unit 430, the signal conversion unit 440 and the operation unit 450 may be embodied in an integrated circuit IC.

The driving circuit unit 420 applies a predetermined driving signal to a first electrode of the panel unit 410. The driving signal may be a Square Wave, a Sine Wave, a Triangular Wave, or the like, which has a predetermined period and amplitude, and is sequentially applied to each of a plurality of first electrodes. It is illustrated that a circuit for generating and applying a driving signal is connected to respective first electrodes among the plurality of first electrodes, respectively, in FIG. 4; however, it is, of course, possible to have one driving signal generation circuit and apply a driving signal to respective first electrodes among the plurality of first electrodes by using a switching circuit.

The sensing circuit unit 430 may include an integration circuit for sensing a change in capacitance C11 to Cmn generated at a plurality of nodes, and the integration circuit may be connected to a plurality of second electrodes. The integration circuit may include at least one operational amplifier and a capacitor C1 having a predetermined capacity. An inverse input terminal of the operational amplifier connected to a second electrode converts and outputs the change in capacitance C11 to Cmn into an analog signal like a voltage signal. Since the integration circuit may detect a change in capacitance from a plurality of second electrodes simultaneously when a driving signal is applied to a plurality of respective first electrodes sequentially, the integration circuit may be provided in an amount equal to m, the number of second electrodes.

The signal conversion unit 440 generates a digital signal S_{D} from an analog signal generated by the integration circuit. For example, the signal conversion unit 440 may include a Time-to-Digital Converter (TDC) circuit, which measures time for an analog signal output in a voltage form from the sensing circuit unit 430 to reach a predetermined reference voltage level and converts the time into a digital signal S_{D}, or an Analog-to-Digital Converter (ADC) circuit, which measures an amount of change in a level of an analog signal output from the sensing circuit unit 430 during a predetermined time and converts the amount into a digital signal S_{D}. The operation unit 450 determines a touch input applied to the panel unit 410 by using the digital signal S_{D}. As an embodiment, the operation unit 450 may determine the number, coordinates and a gesture operation of touch inputs applied to the panel unit 410.

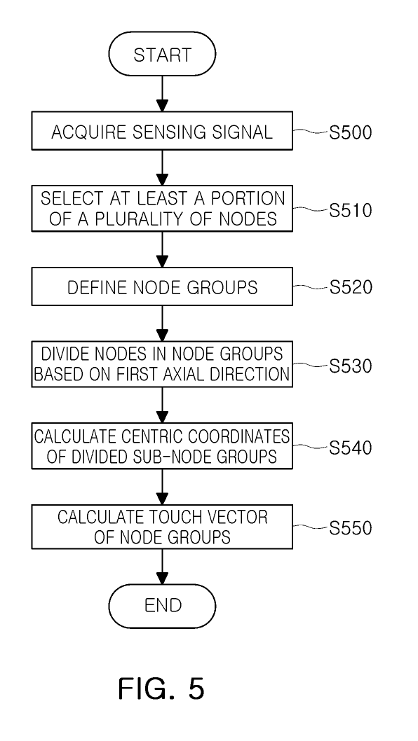

On the other hand, the operation unit 450 of the present embodiment may determine touch input direction information, besides coordinates, the number and a gesture operation of the touch input applied to the panel unit 410. The touch input applied to the panel unit 410 by a user may include direction information depicting a direction of a finger movement. The operation unit 450 of the present embodiment determines direction information, so that the present invention may provide a user with more various input methods. The following is explained in detail referring to FIGS. 5 through 9.

FIG. 5 is a flowchart provided in explaining a method of sensing a touch input according to an embodiment of the present invention.

Referring to FIG. 5, a method of sensing a touch input according to an embodiment of the present invention starts from acquiring a sensing signal by detecting a change in capacitance C11 to Cmn generated in a plurality of nodes in which a first electrode and a second electrode intersect each other (S500). As explained in FIG. 4, the change in capacitance C11 to Cmn may be detected by an integration circuit included in the sensing circuit unit 430, and the sensing circuit unit 430 may generate a voltage signal from the change in capacitance C11 to Cmn. A voltage signal generated by the sensing circuit unit 430 is converted into a sensing signal S_{D} in a digital form by the signal conversion unit 440.

The operation unit 450 selects at least a portion of a plurality of nodes by using the sensing signal S_{D}(S510). When a predetermined driving signal is sequentially applied to each of a plurality of first electrodes and a series of scanning operations, which generate a sensing signal S_{D} by detecting a change in capacitance from a plurality of second electrodes, is once completed, the operation unit 450 selects at least a portion of a plurality of nodes by using a sensing signal S_{D} received as a result of the scan operation. For example, the operation unit 450 may select a node where a sensing signal S_{D} having signal strength more than a predetermined critical value is detected.

The operation unit 450 defines anode group using a node selected in operation S510 (S520). The node group defined by the operation unit 450 may be defined by a node selected in operation S510, and may include an unselected node as well as the node selected in operation S510. The node group defined by the operation unit 450 in operation S520 includes an area in which a touch input actually occurs or an area very close to where the touch input occurs. The operation unit 450 may determine touch input information, by using a sensing signal S_{D} generated from a plurality of nodes included in the node group.

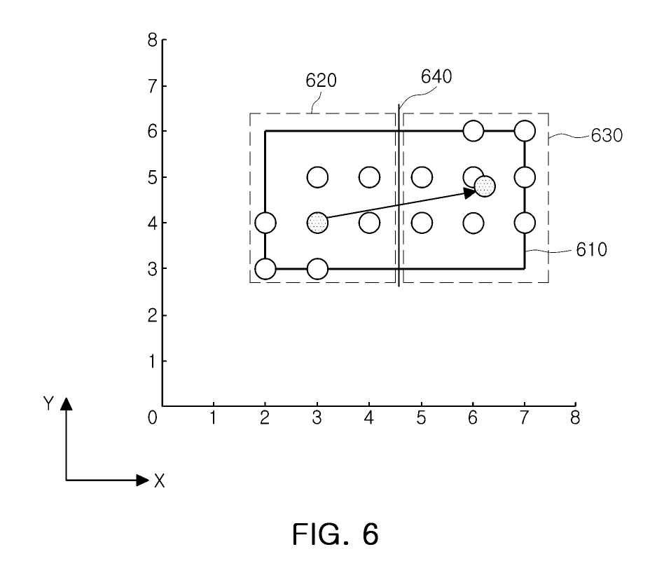

The operation unit 450 generates two or more sub-node groups by dividing a node group defined based on a first axial direction (S530). Each of the two or more sub-node groups includes at least a portion of a plurality of nodes included in a node group defined by the operation unit 450. For example, when total 12 nodes are included in a node group defined in operation S520, each of the two or more sub-node groups may include six nodes. A first axial direction which is a reference for defining a sub-node group is a reference direction for determining directivity of a node group defined in operation S520, and it will be described referring to FIGS. 6 through 9.

When a sub-node group is defined, the operation unit 450 calculates centric coordinates in each sub-node group (S540). The centric coordinates in a sub-node group may be calculated by a weighted average method, which is generally used in calculating, by the operation unit 450, coordinates of a touch input, or calculated by on/off data which indicates whether a sensing signal S_{D} is detected in each of a plurality of nodes included in a sub-node group. When the operation unit 450 calculates centric coordinates in each sub-node group by using the weighted average method, it may calculate centric coordinates of the node group defined in operation S520, i.e., coordinates of a touch input, by using centric coordinates in each sub-node group.

The operation unit 450 calculates a touch vector by using the centric coordinate of each sub-node group calculated in operation S540 (S550). For example, when the node group defined in operation S520 includes two sub-node groups and centric coordinates of respective sub-node groups are calculated, the operation unit 450 may calculate a touch vector in a direction proceeding from centric coordinates of a specific sub-node group to centric coordinates of another sub-node group.

FIGS. 6 through 9 are diagrams provided for explaining a method of sensing a touch input according to an embodiment of the present invention. The following explains the method of sensing a touch input according to the embodiment of the present invention in detail referring to drawings illustrated in FIGS. 6 through 9.

Referring to FIG. 6, anode group 610 including 24 nodes is defined. Among the 24 nodes included in the node group 610, a sensing signal S_{D} is actually detected in 15 nodes, and the operation unit 450 generates two sub-node groups 620 and 630 by dividing the node group 610 by a Y axis direction. Each sub-node group 620 or 630 includes 12 nodes, and a left sub-node group 620 has 7 nodes in which the sensing signal S_{D} is detected and a right sub-node group 630 has 8 nodes in which the sensing signal S_{D} is detected.

As illustrated in FIG. 6, the node group 610 defined by the operation unit 450 may not necessarily include a node where a sensing signal S_{D} is detected (hereinafter, it is defined as a ‘valid node’). The operation unit 450 may determine a touch input based on a sensing signal S_{D} having signal strength more than a predetermined critical value, but the node group 610 defined by the operation unit 450 may include a node where a sensing signal S_{D} having signal strength less than the critical value is generated as well as a valid node. For example, the operation unit 450 may set a boundary of the node group 610 by using a valid node and include all nodes included inside the set boundary in the node group 610.

A reference line 640 for dividing the node group 610 into the sub-node groups 620 and 630 moves in a direction of Y axis in FIG. 6. A direction of the reference line 640 may be defined differently according to a type of the node group 610, and the operation unit 450 may choose a direction perpendicular to a major axis of the node group 610 as a direction of the reference line 640. That is, a major axis of the node group 610 is in a direction of X axis in FIG. 6, so that a line parallel to the direction of Y axis which is perpendicular to the direction of X axis is defined as the reference line 640.

The operation unit 450 calculates centric coordinates in each sub-node group 620 or 630. As illustrated in FIG. 6, the left sub-node group 620 includes 6 different valid nodes which compose a symmetrical structure around a valid node positioned at a coordinate (3, 4). Accordingly, when a general average calculation method which does not weight on signal strength of a sensing signal S_{D} is applied, the centric coordinates of the left sub-node group 620 is calculated to be (3, 4).

The right sub-node group 630 includes 8 valid nodes which do not compose a symmetric structure around a specific valid node. Therefore, the operation unit 450 calculates centric coordinate of the right sub-node group 630 by using a weighted average or general average calculation method. FIG. 6 is a case in which the general average calculation method is applied and signal strength of the sensing signal S_{D} detected in the 8 valid nodes is not weighted. Accordingly, the centric coordinate of the right sub-node group 630 is calculated to be approx. (6.125, 4.875).

The operation unit 450 may define a vector, which proceeds from the centric coordinate (3, 4) of the left sub-node group 620 to the centric coordinate (6.125, 4.875) of the right sub-node group 630, as a touch vector for a touch input which generated the node group 610. That is, the operation unit 450 may calculate a direction of the touch vector to be (3.125, 0.875). This is the case in which the centric coordinate (3, 4) of the left sub-node group 620 is regarded as a starting point. In a case in which the centric coordinate (6.125, 4.875) of the right sub-node group 630 is regarded as a starting point, a direction of the vector may be represented to be reversed.

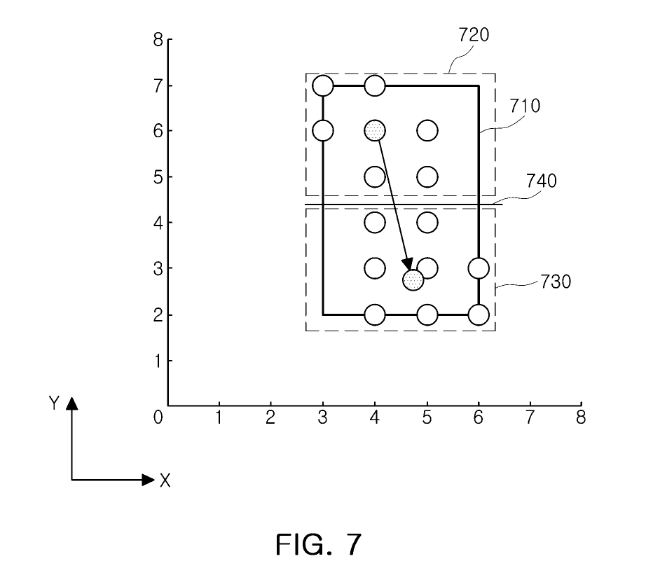

Secondly, referring to FIG. 7, a node group 710 includes 24 nodes in all, and a sensing signal S_{D} having strength more than a critical value is detected in 15 valid nodes out of 24 nodes. Unlike FIG. 6, since a major axis direction of the node group 710 is parallel to a direction of Y axis, a reference line 740 for defining sub-node groups 720 and 730 is set to be parallel to a direction of X axis.

An upper sub-node group 720 includes 7 valid nodes and a lower sub-node group 730 includes 8 valid nodes, based on a reference line 740. As explained in FIG. 6, the operation unit 450 may calculate a touch vector of a whole node group 710 by calculating centric coordinate of the upper sub-node group 720 and centric coordinates of the lower sub-node group 730. The centric coordinate of the upper sub-node group 720 is calculated to be (4, 6) and the centric coordinate of the lower sub-node group 730 is calculated to be (4.875, 2.875) in FIG. 7.

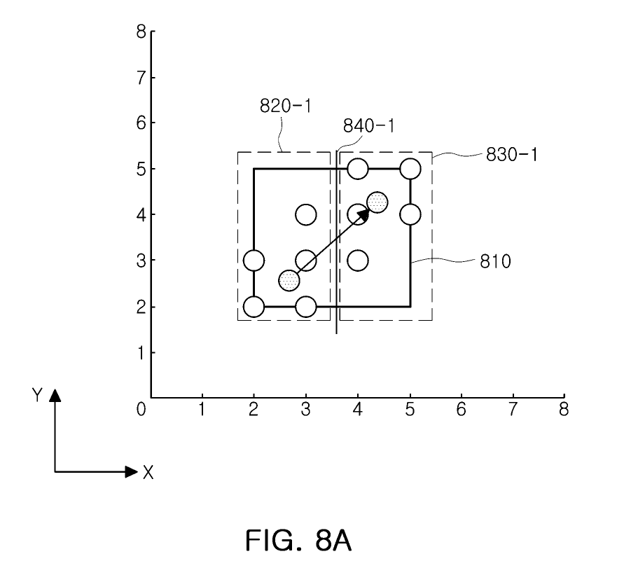

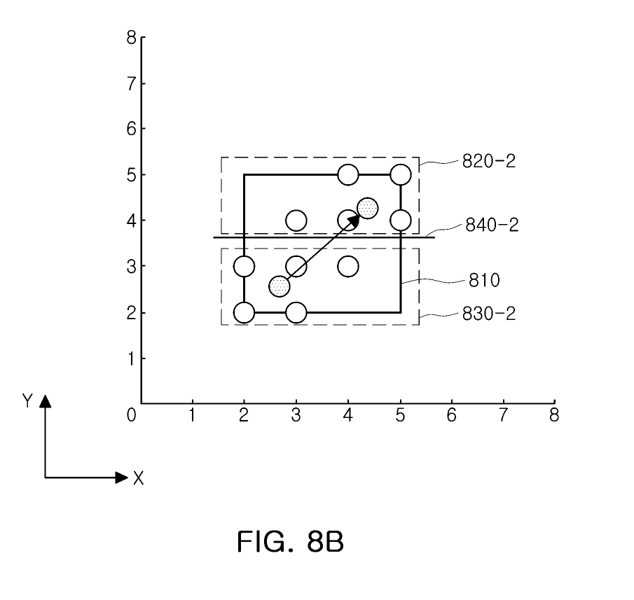

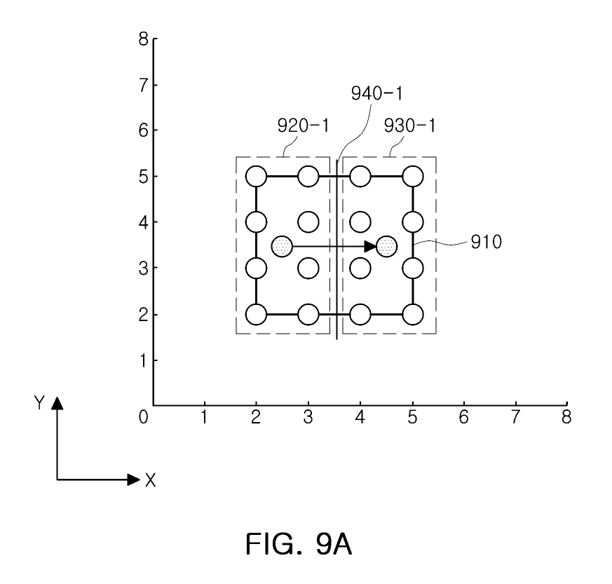

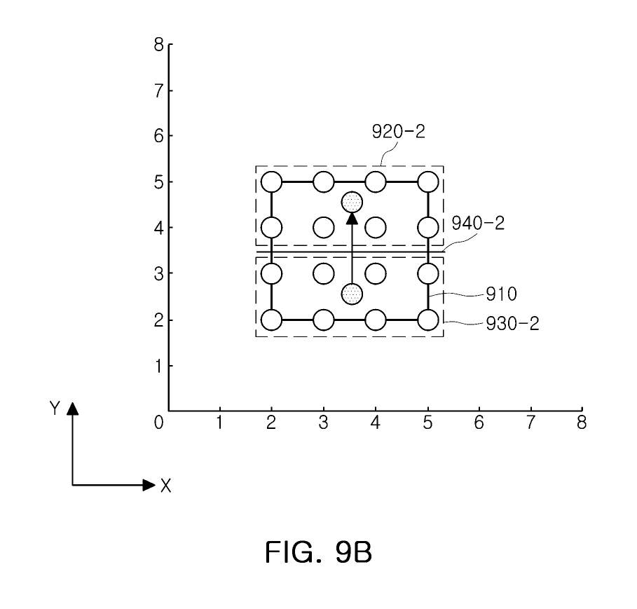

FIGS. 8A and 8B, and 9A and 9B are diagrams for explaining a method of sensing a touch vector in node groups 810 and 910 in a form of square. Referring to FIGS. 8a and 8b, a node group 810 in a form of square is defined and the node group 810 includes 16 nodes in all. A sensing signal S_{D} having strength more than a critical value is generated in 10 nodes out of the 16 nodes.

The operation unit 450 generates first sub-node groups 820-1 and 830-1 by dividing the node group 810 by a reference line 840-1 parallel to a direction of Y axis as illustrated in FIG. 8A. The first sub-node group 820-1 and 830-1 is divided into left and right. A left first sub-node group 820-1 and a right first sub-node group 830-1 include 5 valid nodes, respectively. The operation unit 450 calculates a first touch vector by calculating centric coordinates in each of first sub-node groups 820-1 and 830-1.

Meanwhile, an additional operation may be added to increase accuracy of a touch vector calculation in the node group 810 in a form of square. In other words, as illustrated in FIG. 8B, the operation unit 450 may calculate a second touch vector by dividing the node group 810 into second sub-node groups 820-2 and 830-2 according to a reference line 810-2 different from that of FIG. 8A and calculating each centric coordinate of the second sub-node groups 820-2 and 830-2. The operation unit 450 may determine a final touch vector of the whole node group 810 with an average value of a first touch vector and a second touch vector.

Referring to FIGS. 9A and 9B, 16 nodes included in a node group 910 are all valid nodes. Accordingly, a direction of the first touch vector, which is calculated when first sub-node groups 920-1 and 930-1 are defined by a first reference line 910-1 parallel to a direction of Y axis, is perpendicular to a direction of the first reference line 910-1. In the meantime, a direction of the second touch vector, which is calculated when second sub-node groups 920-2 and 930-2 are defined by a second reference line 910-2 parallel to a direction of X axis, is perpendicular to a direction of the second reference line 910-2. At last, the operation unit 450 determines that a direction of a touch vector of a corresponding node group 910 is absent when a direction of the first touch vector is perpendicular to the first reference line 910-1 and a direction of the second touch vector is perpendicular to the second reference line 910-2. When all nodes included in an initially defined node group 910 are valid nodes, it may be also determined that a direction of a touch vector of the corresponding node group 910 is absent.

As set forth above, according to the embodiments of the present invention, a node group is defined by selecting at least a portion of nodes in which a sensing signal is generated by a touch input and the node group is divided again into two or more first sub-node groups to calculate a vector indicating a direction of the touch input from centric coordinates of the respective first sub-node groups. Accordingly, according to an embodiment of the present invention, directivity as well as coordinates of the touch input may be determined, whereby it may provide a user with high convenience and support various user interfaces and applications.

While the present invention has been shown and described in connection with the embodiments, it will be apparent to those skilled in the art that modifications and variations can be made without departing from the spirit and scope of the invention as defined by the appended claims.

What is claimed is:

1. A method of sensing a touch input, comprising:
selecting at least a portion of a plurality of nodes in which a sensing signal is generated by a touch input;
defining a node group according to the plurality of selected nodes;
generating two or more first sub-node groups by dividing a plurality of nodes included in the node group, based on a direction of a first axis; and
determining a first touch vector of the node group by calculating centric coordinates of the respective two or more first sub-node groups.

2. The method of claim 1, wherein in the determining, the centric coordinates are calculated according to whether the sensing signal is generated in a node included in each of the two or more first sub-node groups.

3. The method of claim 1, wherein in the generating, the two or more first sub-node groups are generated by dividing the node group based on a direction of a first axis intersecting a major axis direction of the node group.

4. The method of claim 1, further comprising:
generating two or more second sub-node groups by dividing the node group based on a second axial direction intersecting the first axial direction; and
determining a second touch vector of the node group by calculating the centric coordinates of the respective two or more second sub-node groups.

5. The method of claim 4, further comprising determining a direction of the node group based on the first touch vector and the second touch vector.

6. The method of claim 5, wherein in the determining, a direction of the node group is determined to be absent when a direction of the first touch vector is perpendicular to the first axial direction and a direction of the second touch vector is perpendicular to the second axial direction.

7. The method of claim 1, wherein a direction of the node group is determiend to be absent when the sensing signal is determined to be generated in all nodes included in the node group.

8. The method of claim 1, further comprising determining coordinates of the node group by calculating an average of the centric coordinate of each of the two or more first sub-node groups.

9. An apparatus for sensing a touch input, comprising:
a panel unit including a plurality of nodes in which a sensing signal is generated by a touch input; and
an operation unit determining touch input information, based on the sensing signal,
the operation unit defining a node group including at least a portion of the plurality of nodes, based on the sensing signal, generating two or more first sub-node groups by dividing the node group based on a first axial direction, and calculating a first vector of the touch input by calculating centric coordinates of the respective two or more first sub-node groups.

10. The apparatus of claim 9, wherein the operation unit includes:
a sensing circuit unit detecting a change in capacitance generated in the plurality of nodes by the touch input; and
a signal conversion unit generating the sensing signal according to the change in capacitance.

11. The apparatus of claim 9, wherein the operation unit calculates the centric coordinates based on whether the sensing signal is generated in a node included in each of the two or more first sub-node groups.

12. The apparatus of claim 9, wherein the operation unit generates the two or more first sub-node groups by dividing the node group based on the first axial direction intersecting a major direction of the node group.

13. The apparatus of claim 9, wherein the operation unit generates two or more second sub-node groups by dividing the node group based on a second axial direction intersecting the first axial direction, and determine a second touch vector of the node group by calculating the centric coordinates of the respective two or more second sub-node groups.

14. The apparatus of claim 13, wherein a direction of the node group is determined based on the first touch vector and the second touch vector.

15. The apparatus of claim 14, wherein the operation unit determines that a direction of the node group is absent when a direction of the first touch vector is perpendicular to the first axial direction and a direction of the second touch vector is perpendicular to the second axial direction.

16. The apparatus of claim 9, wherein the operation unit determines that a direction of the node group is absent when the sensing signal is determined to be generated in all nodes included in the node group.

17. The apparatus of claim 9, wherein the operation unit determines coordinates of the node group by calculating an average of the centric coordinates of the respective two or more first sub-node groups.
